(19) United States
(12) Patent Application Publication
(10) Pub. No.: US 2008/0158160 A1
(43) Pub. Date: Jul. 3, 2008

(54) CENTRAL STORAGE FOR DATA ENTRY PROCESSING

(76) Inventor: Christof Engel, Rauenberg (DE)

Correspondence Address: SCHWEGMAN, LUNDBERG & WOESSNER/SAP, P.O. BOX 2938, MINNEAPOLIS, MN, 55402, US

(21) Appl. No.: 11/618,239

(22) Filed: Dec. 29, 2006

(51) Int. Cl. G06F 3/02

(52) U.S. Cl. 345/168

(57) ABSTRACT

A method for filing out electronic forms comprising Identifying data fields in an electronic form, receiving input from a user for at least one data field of the electronic form, retrieving or selecting from a database candidates for data field entries for the electronic from, based on the received input from the user and a user identification, and proposing a data field entry based on the selection.

### TECHNICAL FIELD

Embodiments relate to the field of electronic data processing and more particularly to data entry in electronic forms.

### BACKGROUND AND PRIOR ART

In computer based data processing, in many instances user input is requested in the form of electronic forms. For example, web based forms require a user to input user data like name, address and so on. Although electronic forms speed up operation quite well, a user still has to make a considerable effort inputting different user data.

Known is to improve the speed of inputting data by providing an autofill option, in which prior entries are stored and prompted to the user to input in a certain field.

### SUMMARY OF THE INVENTION

An aspect is to provide a method and system to more efficiently input user data in an electronic form.

### BRIEF DESCRIPTION OF DRAWINGS

FIG. 1 is a diagram of an example of an electronic form, according to an embodiment.

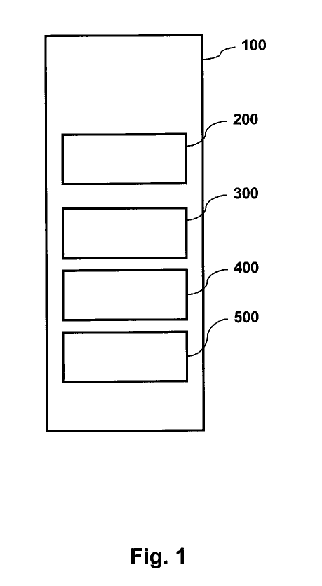

FIG. 2 is a diagram of an example of a system, according to an embodiment.

FIG. 3 is a flow diagram of a method, according to an embodiment.

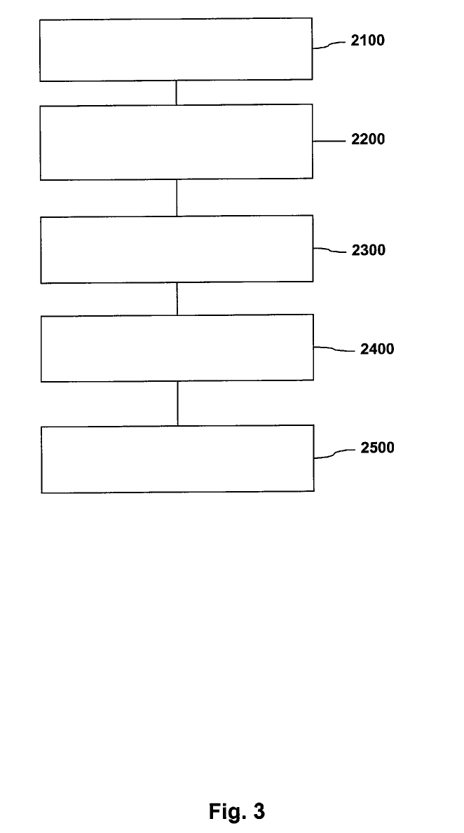

### DETAILED DESCRIPTION

According to an embodiment of the invention, an electronic form 100 is provided. The electronic form can be implemented as for example a HTML based web form. The electronic form 100 can be used in any application that requires data input from a user. The electronic form can be communicatively connected using suitable known means to a software application, like for example a business application. The electronic form contains in this example multiple form fields, in this example Last Name 200, First Name 300, Street Name 400, ZIP code 500. The collection of form fields can be named a form set. Note that the form fields can be of any type, and are not limited to text fields, but can also include for example select boxes and radio buttons.

Further provided in this example is a selector 1000, provided with an entry database 1100. The selector 1000 can be implemented for example in a software application, or software code, and be for example running on either a client or server side in a client server system or be implemented as a service in for example a web based setting. The selector 1000 can also be implemented as part of a browser. The implementation of the selector 1000 is not limited to these examples, but can be implemented in any suitable form.

The entry database 1100 contains data in the form of data sets. Each data set consists of a number of data field identifiers (like first name, last name, street name), and respective data entries (like “John”, “Smith”, “Broadway”). Typically, a data set would correspond to a certain electronic form that was already filled out once by the user.

The entry database 1100 contains also user identification data to link data to specific users. Also, data fields are maintained for specific users. Typically, this can be done centrally, for example in a records department of a company. Here the data can be guided and directed so that it complies with company policies for instance. Also data consistency can be maintained more easily.

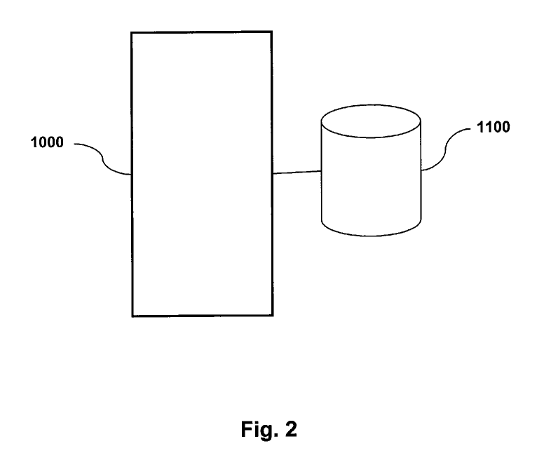

In the example, a user selects a first form field to fill out, and inputs using a suitable method, like in this example a web browser, this first form field entry. In the example, the user enters his data in the Last Name 200 form field, receiving user input in step 2100 of FIG. 2. In addition a user identification is transmitted using any suitable known means, where the user identification can be for example unique or role based.

The selector 1000 analyses the electronic form 100, by identifying the fields contained in the form 1000, thereby forming a form set, making up step 2200 in FIG. 2. Analysis of electronic forms, which typically are not standardized, is as such known in the prior art. Known is for example to analyze the web page coding to determine the data fields, the start and end of the form, the associated text and the like. The analysis yields are set of data fields to be filled out on the electronic form.

The selector 1000 now uses the information available in the database to find data sets that potentially can match the form set as deduced from the electronic form, step 2300 in FIG. 2. Also, the user identification is used to select sets that are allowable or available for the specific user. The form set can have a more, less or equal number of entries compared to the database set. In one embodiment of the invention, Based on the first entry made by the user, the selector 1000 searches the entry database 1100 for corresponding entries, and retrieves one or more sets of possible candidates for filling out at least part of the remaining form fields. The matching of the sets can be implemented using any suitable known matching method. By having a centrally maintained data set, a user can only select a predefined and correct data set, thus increasing the accuracy of data entry.

The list with potential candidates is listed on the screen to the user, step 2400 in FIG. 2. The user can select a candidate from the list. The selected data entries are inputted into the respective form fields, step 2500. By providing the user with a proposal for filling out at least some of the remaining form fields, the time needed to fill out the form can be reduced. Additionally, accuracy of the data entry could be improved.

In one embodiment of the invention, only a single proposed set is shown to the user. An example of a selection criterion for the single proposed set can be for example the most matching items with the sets, or for example a prerecorded user preference for specific items, for which a match yields a higher priority. In this case, the alternative with the highest priority can be selected.

In one embodiment of the invention, a list with multiple possible candidate sets is shown to the user. For example, the candidate sets can be shown in for example a drop down list style, where a line corresponds to a set, and the columns indicate the respective data fields. A first line can be provided indicating the respective titles of the data items.

In one embodiment the user can in addition enter yet another data field entry; now the selector will use the additional data entry as an additional search criterion. This can reduce the number of possible candidate sets, and therefore reduce the selection effort made by the user.

If the database does not contain any entries that match, no set or an empty set is returned.

In one embodiment the selector is provided with an entry generator. The entry generator analysis the data entry behavior of the user to generate sets of matching form fields and data entries. This can be implemented for instances by using known machine learning techniques. These can include for example decision trees, neural networks, logistic regression and support vector machines.

As noted above, example embodiments may include computer program products. The computer program products may be stored on computer-readable media for carrying or having computer-executable instructions or data structures. Such computer-readable media may be any available media that can be accessed by a general purpose or special purpose computer. By way of example, such computer-readable media may include RAM, ROM, EPROM, EEPROM, CD-ROM or other optical disk storage, magnetic disk storage or other magnetic storage devices, or any other medium that may be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is an example of a computer-readable medium. Combinations of the above are also to be included within the scope of computer-readable media. Computer-executable instructions include, for example, instructions and data which cause a general purpose computer, a special purpose computer, or a special purpose processing device to perform a certain function or group of functions. Furthermore, computer-executable instructions include, for example, instructions that have to be processed by a computer to transform the instructions into a format that is executable by a computer. The computer-executable instructions may be in a source format that is compiled or interpreted to obtain the instructions in the executable format. When the computer-executable instructions are transformed, a first computer may for example transform the computer-executable instructions into the executable format and a second computer may execute the transformed instructions. The computer-executable instructions may be organized in a modular way so that a part of the instructions may belong to one module and a further part of the instructions may belong to a further module. However, the differences between different modules may not be obvious and instructions of different modules may be intertwined.

Example embodiments have been described in the general context of method operations, which may be implemented in one embodiment by a computer program product including computer-executable instructions, such as program code, executed by computers in networked environments. Generally, program modules include for example routines, programs, objects, components, or data structures that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such operations.

Some embodiments may be operated in a networked environment using logical connections to one or more remote computers having processors. Logical connections may include for example a local area network (LAN) and a wide area network (WAN). The examples are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An example system for implementing the overall system or portions might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

Software and web implementations could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, hardware implementations, or equipment for receiving manual inputs.

1. A method for filling out electronic forms comprising:
Identifying data fields in an electronic form,
Receiving input from a user for at least one data field of said electronic form,
Receiving a user identification,
Selecting from a database candidates for data field entries for said electronic from, based on said received input from the user and said user identification, and
Proposing a data field entry based on said selection.

2. The method of claim 1, comprising:
Receiving input from a user for at further data field entry of said electronic form, and selecting a candidate based on said further data field entry and said user identification.

3. The method of claim 1, comprising:
Proposing a multiple of data field entries based on said selection.

4. The method of claim 1, comprising:
Receiving input from a user selecting a data field entry, and
Filling out said electronic form with the user selected data field entry.
